(19) United States
(12) Patent Application Publication
(10) Pub. No.: US 2018/0020668 A1
(43) Pub. Date: Jan. 25, 2018

(54) Agricultural Mixtures

(71) Applicant: Valent U.S.A. LLC, Walnut Creek, CA (US)

(72) Inventors: Karen S. Arthur, Plano, TX (US); Billy R. Corbin, JR., Greenville, MS (US)

(21) Appl. No.: 15/693,954

(22) Filed: Sep. 1, 2017

Related U.S. Application Data
(62) Division of application No. 15/198,659, filed on Jun. 30, 2016.
(60) Provisional application No. 62/188,286, filed on Jul. 2, 2015.

(51) Int. Cl. A01N 57/14; A01N 37/46; A01N 43/56; A01N 43/653; A01N 51/00; A01N 43/12; A01N 43/28; A01N 43/36; A01N 43/78; A01N 45/00

(52) U.S. Cl. CPC A01N 57/14; A01N 43/78; A01N 37/46; A01N 43/56; A01N 45/00; A01N 51/00; A01N 43/12; A01N 43/28; A01N 43/36; A01N 43/653

(57) ABSTRACT

The present invention is directed to agricultural mixtures comprising 3-(difluoromethyl)-1-methyl-N-[(3R)-1,1,3-trimethyl-2,3-dihydroinden-4-yl]pyrazole-4-carboxamide, ethaboxam, and metalaxyl.

### FIELD OF THE INVENTION

The present invention is generally directed to agricultural mixtures comprising 3-(difluoromethyl)-1-methyl-N-[(3R)-1,1,3-trimethyl-2,3-dihydroinden-4-yl]pyrazole-4-carboxamide, ethaboxam, and metalaxyl, and methods of use thereof.

### BACKGROUND

Seed rot, seedling decay (damping-off), and seedling disease can reduce plant emergence and decrease yields. These blights are caused by a number of pathogens. Unfortunately, contemporary agronomic practices are exacerbating the problem. The current trend towards early planting in cold, wet soils, reduced tillage or no-till fields favors an environment conducive to the pathogen growth over the growth and development of the planted seed.

Seed treatments are an efficient method used to control pathogens as the actives are applied directly to the seed and are present on the seed and in the seed zone, protecting the germinating seed and seedling during early growth and development. Seed treatments are applied prior to planting. It is important to utilize approved commercial, recently calibrated, seed treatment equipment to insure excellent seed coverage and uniformity over the seed-coats. This method of application requires seed treating personnel to use and safely operate seed treatment equipment. Providing pre-treated seeds to end users is an economical alternative to drench, in-furrow, or foliar applications of seed or plant protection products.

The widespread use of foliar fungicides has resulted in a build-up of resistance in the pathogens. Accordingly, the effectiveness of presently used fungicides is diminishing if they are applied alone.

Solo fungicide applications used frequently and without alternating or mixing with fungicides of different modes of action has led to pathogen resistance. For example, Phytophthora and downy mildew fungi have shown resistance to metalaxyl. Rhizoctonia has shown resistance to azoxystrobin. Pathogen resistance is a major concern because it can cause sudden crop failures resulting in severe reductions in crop yields.

U.S. Pat. No. 7,598,395 B2 describes agricultural compositions comprising the succinate dehydrogenase inhibitor (“SDHI”) isopyrazam, 3-difluoromethyl-1-methyl-1H-pyrazole-4-carboxylic acid (9-isopropyl-1,2,3,4-tetrahydro-1,4-methano-naphthalen-5-yl)-amide (available from Syngenta). U.S. Pat. No. 7,538,073 B2 is directed to pyrazolylcarboxanilides including penflufen, N-[2-(1,3-dimethylbutyl)phenyl]-5-fluoro-1,3-dimethyl-1H-pyrazole-4-carboxamide (available from Bayer CropScience LP). Sedaxane, N-[2-[1,1′-bicyclopropyl]-2-ylphenyl]-3-(difluoromethyl)-1-methyl-1H-pyrazole-4-carboxamide is another commercially available SDHI (Vibrance™, also available from Syngenta). WO Application No. 2006/087343 discloses another SDHI, fluxapyroxad, 3-(difluoromethyl)-1-methyl-N-(3′,4′,5′-trifluoro[1,1′-biphenyl]-2-yl)-1H-pyrazole-4-carboxamide (available from BASF). While it is known that these SDHIs have fungicidal activity, their activity is not always acceptable for some applications. Further, the commercially available SDHIs do not provide broad spectrum coverage, meaning they do not provide protection from several different types of fungi.

Accordingly, there is a need in the art for effective pesticidal seed treatments, especially fungicidal treatments. The seed treatments should have broad spectrum activity to protect the seed and seedlings from the diverse fungal pathogens present in the soil, which discourage pesticide resistance or tolerance, have little-to-no phytotoxicity, and should be safe and easy for the seed treat applicator and end user.

### SUMMARY OF THE INVENTION

In one aspect, the invention is directed to agricultural mixtures comprising 3-(difluoromethyl)-1-methyl-N-[(3R)-1,1,3-trimethyl-2,3-dihydroinden-4-yl]pyrazole-4-carboxamide, ethaboxam, and metalaxyl.

In a further aspect, the invention is directed to methods for increasing plant yield comprising applying agricultural mixtures comprising 3-(difluoromethyl)-1-methyl-N-[(3R)-1,1,3-trimethyl-2,3-dihydroinden-4-yl]pyrazole-4-carboxamide, ethaboxam, and metalaxyl onto a plant propagation material.

In another aspect, the invention is directed to methods for controlling or preventing pest damage of plants comprising applying agricultural mixtures comprising 3-(difluoromethyl)-1-methyl-N-[(3R)-1,1,3-trimethyl-2,3-dihydroinden-4-yl]pyrazole-4-carboxamide, ethaboxam, and metalaxyl onto a plant propagation material.

### DETAILED DESCRIPTION

Applicants unexpectedly found that mixtures of the present invention provided superior control of pests. The superior control of pests allowed for more plants to grow and for healthier plants to mature.

Applicants unexpectedly found that 3-(difluoromethyl)-1-methyl-N-[(3R)-1,1,3-trimethyl-2,3-dihydroinden-4-yl]pyrazole-4-carboxamide exhibited better activity against fungi than SDHIs that are commercially available. 3-(Difluoromethyl)-1-methyl-N-[(3R)-1,1,3-trimethyl-2,3-dihydroinden-4-yl]pyrazole-4-carboxamide provides desirable broad spectrum coverage when provided in mixtures of the present invention.

In one embodiment, the invention is directed to agricultural mixtures comprising 3-(difluoromethyl)-1-methyl-N-[(3R)-1,1,3-trimethyl-2,3-dihydroinden-4-yl]pyrazole-4-carboxamide, ethaboxam, and metalaxyl.

In another embodiment, the invention is directed to agricultural mixtures comprising 3-(difluoromethyl)-1-methyl-N-[(3R)-1,1,3-trimethyl-2,3-dihydroinden-4-yl]pyrazole-4-carboxamide, ethaboxam, and metalaxyl wherein the ratio of 3-(difluoromethyl)-1-methyl-N-[(3R)-1,1,3-trimethyl-2,3-dihydroinden-4-yl]pyrazole-4-carboxamide to ethaboxam is from about 1:0.125 to about 1:150. Preferably the ratio of 3-(difluoromethyl)-1-methyl-N-[(3R)-1,1,3-trimethyl-2,3-dihydroinden-4-yl]pyrazole-4-carboxamide to ethaboxam is from about 1:0.67 to about 1:18, with a most preferred ratio being from about 1:0.67 to about 1:8.

In another embodiment, the invention is directed to agricultural mixtures comprising 3-(difluoromethyl)-1-methyl-N-[(3R)-1,1,3-trimethyl-2,3-dihydroinden-4-yl]pyrazole-4-carboxamide, ethaboxam, and metalaxyl wherein the ratio of 3-(difluoromethyl)-1-methyl-N-[(3R)-1,1,3-trimethyl-2,3-dihydroinden-4-yl]pyrazole-4-carboxamide to metalaxyl is from about 1:0.025 to about 1:300. Preferably the ratio of 3-(difluoromethyl)-1-methyl-N-[(3R)-1,1,3-trimethyl-2,3-dihydroinden-4-yl]pyrazole-4-carboxamide to metalaxyl is from about 1:0.067 to about 1:20, with a most preferred ratio being from about 1:0.27 to about 1:8.

In another embodiment, the invention is directed to agricultural mixtures comprising 3-(difluoromethyl)-1-methyl-N-[(3R)-1,1,3-trimethyl-2,3-dihydroinden-4-yl]pyrazole-4-carboxamide, ethaboxam, and metalaxyl wherein the ratio of ethaboxam to metalaxyl is from about 1:0.11 to about 1:12. Preferably the ratio of ethaboxam to metalaxyl is from about 1:0.11 to about 1:3.3, with a most preferred ratio being from about 1:0.25 to about 1:1.6.

In another embodiment, the invention is directed to agricultural mixtures comprising 3-(difluoromethyl)-1-methyl-N-[(3R)-1,1,3-trimethyl-2,3-dihydroinden-4-yl]pyrazole-4-carboxamide, ethaboxam, and metalaxyl wherein the ratio of 3-(difluoromethyl)-1-methyl-N-[(3R)-1,1,3-trimethyl-2,3-dihydroinden-4-yl]pyrazole-4-carboxamide to ethaboxam to metalaxyl is from about 1:0.125:0.025 to about 1:150:300. Preferably the ratio of 3-(difluoromethyl)-1-methyl-N-[(3R)-1,1,3-trimethyl-2,3-dihydroinden-4-yl]pyrazole-4-carboxamide to ethaboxam to metalaxyl is from about 1:0.67:0.067 to about 1:18:20, with a most preferred ratio being from about 1:0.67:0.27 to about 1:8:8.

In another embodiment, the invention is directed to an agricultural mixture comprising 3-(difluoromethyl)-1-methyl-N-[(3R)-1,1,3-trimethyl-2,3-dihydroinden-4-yl]pyrazole-4-carboxamide, ethaboxam, metalaxyl and/or a neonicotinoid and/or 2-[2-(2,5-dimethylphenoxymethyl)phenyl]-2-methoxy-N-methylacetamide and/or metconazole and/or tolclofos-methyl.

In a preferred embodiment, the invention is directed to an agricultural mixture comprising 3-(difluoromethyl)-1-methyl-N-[(3R)-1,1,3-trimethyl-2,3-dihydroinden-4-yl]pyrazole-4-carboxamide, ethaboxam, metalaxyl and/or clothianidin and/or 2-[2-(2,5-dimethylphenoxymethyl)phenyl]-2-methoxy-N-methylacetamide and/or metconazole and/or tolclofos-methyl.

In a preferred embodiment, the agricultural mixture includes 3-(difluoromethyl)-1-methyl-N-[(3R)-1,1,3-trimethyl-2,3-dihydroinden-4-yl]pyrazole-4-carboxamide, ethaboxam, metalaxyl and metconazole.

In a preferred embodiment, the agricultural mixture includes 3-(difluoromethyl)-1-methyl-N-[(3R)-1,1,3-trimethyl-2,3-dihydroinden-4-yl]pyrazole-4-carboxamide, ethaboxam, metalaxyl and a neonicotinoid.

In a preferred embodiment, the agricultural mixture includes 3-(difluoromethyl)-1-methyl-N-[(3R)-1,1,3-trimethyl-2,3-dihydroinden-4-yl]pyrazole-4-carboxamide, ethaboxam, metalaxyl and clothianidin.

In a preferred embodiment, the agricultural mixture includes 3-(difluoromethyl)-1-methyl-N-[(3R)-1,1,3-trimethyl-2,3-dihydroinden-4-yl]pyrazole-4-carboxamide, ethaboxam, metalaxyl and 2-[2-(2,5-dimethylphenoxymethyl)phenyl]-2-methoxy-N-methylacetamide.

In a preferred embodiment, the agricultural mixture includes 3-(difluoromethyl)-1-methyl-N-[(3R)-1,1,3-trimethyl-2,3-dihydroinden-4-yl]pyrazole-4-carboxamide, ethaboxam, metalaxyl, metconazole and a neonicotinoid.

In a preferred embodiment, the agricultural mixture includes 3-(difluoromethyl)-1-methyl-N-[(3R)-1,1,3-trimethyl-2,3-dihydroinden-4-yl]pyrazole-4-carboxamide, ethaboxam, metalaxyl, metconazole and clothianidin.

In a preferred embodiment, the agricultural mixture includes 3-(difluoromethyl)-1-methyl-N-[(3R)-1,1,3-trimethyl-2,3-dihydroinden-4-yl]pyrazole-4-carboxamide, ethaboxam, metalaxyl, metconazole and 2-[2-(2,5-dimethylphenoxymethyl)phenyl]-2-methoxy-N-methylacetamide.

In a preferred embodiment, the agricultural mixture includes 3-(difluoromethyl)-1-methyl-N-[(3R)-1,1,3-trimethyl-2,3-dihydroinden-4-yl]pyrazole-4-carboxamide, ethaboxam, metalaxyl, clothianidin and 2-[2-(2,5-dimethylphenoxymethyl)phenyl]-2-methoxy-N-methylacetamide.

In a preferred embodiment, the agricultural mixture includes 3-(difluoromethyl)-1-methyl-N-[(3R)-1,1,3-trimethyl-2,3-dihydroinden-4-yl]pyrazole-4-carboxamide, ethaboxam, metalaxyl, clothianidin and tolclofos-methyl.

In a preferred embodiment, the agricultural mixture includes 3-(difluoromethyl)-1-methyl-N-[(3R)-1,1,3-trimethyl-2,3-dihydroinden-4-yl]pyrazole-4-carboxamide, ethaboxam, metalaxyl, 2-[2-(2,5-dimethylphenoxymethyl)phenyl]-2-methoxy-N-methylacetamide and tolclofos-methyl.

In a preferred embodiment, the agricultural mixture includes 3-(difluoromethyl)-1-methyl-N-[(3R)-1,1,3-trimethyl-2,3-dihydroinden-4-yl]pyrazole-4-carboxamide, ethaboxam, metalaxyl, metconazole and tolclofos-methyl.

In another embodiment, the agricultural mixture includes 3-(difluoromethyl)-1-methyl-N-[(3R)-1,1,3-trimethyl-2,3-dihydroinden-4-yl]pyrazole-4-carboxamide, ethaboxam, metalaxyl, and/or a neonicotinoid and/or 2-[2-(2,5-dimethylphenoxymethyl)phenyl]-2-methoxy-N-methylacetamide and/or metconazole and/or tolclofos-methyl and/or thiamethoxam.

In another embodiment, the agricultural mixture includes 3-(difluoromethyl)-1-methyl-N-[(3R)-1,1,3-trimethyl-2,3-dihydroinden-4-yl]pyrazole-4-carboxamide, ethaboxam, metalaxyl, and/or clothianidin and/or 2-[2-(2,5-dimethylphenoxymethyl)phenyl]-2-methoxy-N-methylacetamide and/or metconazole and/or tolclofos-methyl and/or thiamethoxam.

The mixtures of the present invention could also include other agriculturally acceptable actives.

In another embodiment, the invention is directed to methods for increasing plant yield comprising applying the mixture of agricultural mixtures comprising 3-(difluoromethyl)-1-methyl-N-[(3R)-1,1,3-trimethyl-2,3-dihydroinden-4-yl]pyrazole-4-carboxamide, ethaboxam, and metalaxyl onto a plant propagation material.

As used herein, “plant propagation material” refers to seeds, bulbs, rhizomes and tubers.

In a preferred embodiment, the plant propagation material is a seed. In a more preferred embodiment, the mixtures of the present invention are applied to the seeds before they are planted.

In another preferred embodiment, the plant that is treated is a crop plant. In a more preferred embodiment, the crop plant is selected from the group consisting of corn, soybeans, wheat, rice, canola, sorghum, barley, oats, rye, millet and sugar beets.

In an embodiment of the invention, from about 0.1 to about 20 grams of 3-(difluoromethyl)-1-methyl-N-[(3R)-1,1,3-trimethyl-2,3-dihydroinden-4-yl]pyrazole-4-carboxamide per 100 kg of plant propagation material is applied to the plant propagation material. Preferably from about 0.5 to about 15 grams of 3-(difluoromethyl)-1-methyl-N-[(3R)-1,1,3-trimethyl-2,3-dihydroinden-4-yl]pyrazole-4-carboxamide, and more preferably from about 1.0 to about 7.5 grams of 3-(difluoromethyl)-1-methyl-N-[(3R)-1,1,3-trimethyl-2,3-dihydroinden-4-yl]pyrazole-4-carboxamide per 100 kg of plant propagation material is applied to the plant propagation material.

In an embodiment of the invention, from about 0.1 to about 20 grams of 3-(difluoromethyl)-1-methyl-N-[(3R)-1,1,3-trimethyl-2,3-dihydroinden-4-yl]pyrazole-4-carboxamide per 100 kg of seed is applied to the seeds. Preferably from about 0.5 to about 15 grams of 3-(difluoromethyl)-1-methyl-N-[(3R)-1,1,3-trimethyl-2,3-dihydroinden-4-yl]pyrazole-4-carboxamide, and more preferably from about 1.0 to about 7.5 grams of 3-(difluoromethyl)-1-methyl-N-[(3R)-1,1,3-trimethyl-2,3-dihydroinden-4-yl]pyrazole-4-carboxamide per 100 kg of seed is applied to the seeds.

In an embodiment of the invention, from about 0.0001 to about 0.1 milligrams of 3-(difluoromethyl)-1-methyl-N-[(3R)-1,1,3-trimethyl-2,3-dihydroinden-4-yl]pyrazole-4-carboxamide is applied to a seed. Preferably from about 0.001 to about 0.1 milligrams of 3-(difluoromethyl)-1-methyl-N-[(3R)-1,1,3-trimethyl-2,3-dihydroinden-4-yl]pyrazole-4-carboxamide, and more preferably from about 0.003 to about 0.03 milligrams of 3-(difluoromethyl)-1-methyl-N-[(3R)-1,1,3-trimethyl-2,3-dihydroinden-4-yl]pyrazole-4-carboxamide is applied to a seed.

In an embodiment of the invention, from about 0.5 to about 30 grams of metalaxyl per 100 kg of plant propagation material is applied to the plant propagation material. Preferably from about 1 to about 10 grams of metalaxyl, and more preferably from about 2 to about 8 grams of metalaxyl per 100 kg of plant propagation material is applied to the plant propagation material.

In an embodiment of the invention, from about 0.5 to about 30 grams of metalaxyl per 100 kg of seed is applied to the seeds. Preferably from about 1 to about 10 grams of metalaxyl, and more preferably from about 2.0 to about 8.0 grams of metalaxyl per 100 kg of seed is applied to the seeds.

In an embodiment of the invention, from about 0.0001 to about 1.0 milligrams of metalaxyl is applied to a seed. Preferably from about 0.001 to about 0.010 milligrams of metalaxyl, and more preferably from about 0.003 to about 0.008 milligrams of metalaxyl is applied to a seed.

In an embodiment of the invention, from about 2.5 to about 15 grams of ethaboxam per 100 kg of plant propagation material is applied to the plant propagation material. Preferably from about 3 to about 9 grams of ethaboxam, and more preferably from about 5 to about 8 grams of ethaboxam per 100 kg of plant propagation material is applied to the plant propagation material.

In an embodiment of the invention, from about 2.5 to about 15 grams of ethaboxam per 100 kg of seed is applied to the seeds. Preferably from about 3 to about 9 grams of ethaboxam, and more preferably from about 5 to about 8 grams of ethaboxam per 100 kg of seed is applied to the seeds.

In an embodiment of the invention, from about 0.001 to about 1.0 milligrams of ethaboxam is applied to a seed. Preferably from about 0.001 to about 0.5 milligrams of ethaboxam, and more preferably from about 0.012 to about 0.25 milligrams of ethaboxam is applied to a seed.

In an embodiment of the invention, from about 0.5 to about 20 grams of metconazole per 100 kg of plant propagation material is applied to the plant propagation material. Preferably from about 1 to about 8 grams of metconazole, and more preferably from about 3 to about 6 grams of metconazole per 100 kg of plant propagation material is applied to the plant propagation material.

In an embodiment of the invention, from about 0.5 to about 20 grams of metconazole per 100 kg of seed is applied to the seeds. Preferably from about 1 to about 8 grams of metconazole, and more preferably from about 3 to about 6 grams of metconazole per 100 kg of seed is applied to the seeds.

In an embodiment of the invention, from about 0.5 to about 20 grams of a neonicotinoid per 100 kg of seed is applied to the seeds. Preferably from about 2 to about 15 grams of a neonicotinoid, and more preferably from about 4 to about 10 grams of a neonicotinoid per 100 kg of seed is applied to the seeds.

In an embodiment of the invention, from about 0.5 to about 20 grams of a neonicotinoid per 100 kg of plant propagation material is applied to the plant propagation material. Preferably from about 2 to about 15 grams of a neonicotinoid, and more preferably from about 4 to about 10 grams of a neonicotinoid per 100 kg of plant propagation material is applied to the plant propagation material.

In an embodiment of the invention, from about 0.5 to about 20 grams of clothianidin per 100 kg of seed is applied to the seeds. Preferably from about 2 to about 15 grams of clothianidin, and more preferably from about 4 to about 10 grams of clothianidin per 100 kg of seed is applied to the seeds.

In an embodiment of the invention, from about 0.5 to about 20 grams of clothianidin per 100 kg of plant propagation material is applied to the plant propagation material. Preferably from about 2 to about 15 grams of clothianidin, and more preferably from about 4 to about 10 grams of clothianidin per 100 kg of plant propagation material is applied to the plant propagation material.

In an embodiment of the invention, from about 2 to about 15 grams of 2-[2-(2,5-dimethylphenoxymethyl)phenyl]-2-methoxy-N-methylacetamide per 100 kg of seed is applied to the seeds. Preferably from about 3 to about 9 grams of 2-[2-(2,5-dimethylphenoxymethyl)phenyl]-2-methoxy-N-methylacetamide, and more preferably from about 6 to about 8 grams of 2-[2-(2,5-dimethylphenoxymethyl)phenyl]-2-methoxy-N-methylacetamide per 100 kg of seed is applied to the seeds.

In an embodiment of the invention, from about 2 to about 15 grams of 2-[2-(2,5-dimethylphenoxymethyl)phenyl]-2-methoxy-N-methylacetamide per 100 kg of plant propagation material is applied to the plant propagation material. Preferably from about 3 to about 9 grams of 2-[2-(2,5-dimethylphenoxymethyl)phenyl]-2-methoxy-N-methylacetamide, and more preferably from about 6 to about 8 grams of 2-[2-(2,5-dimethylphenoxymethyl)phenyl]-2-methoxy-N-methylacetamide per 100 kg of plant propagation material is applied to the plant propagation material.

In an embodiment of the invention, from about 2 to about 15 grams of tolclofos-methyl per 100 kg of seed is applied to the seeds. Preferably from about 3 to about 9 grams of tolclofos-methyl, and more preferably from about 6 to about 8 grams of tolclofos-methyl per 100 kg of seed is applied to the seeds.

In an embodiment of the invention, from about 2 to about 15 grams of tolclofos-methyl per 100 kg of plant propagation material is applied to the plant propagation material. Preferably from about 3 to about 9 grams of tolclofos-methyl, and more preferably from about 6 to about 8 grams of tolclofos-methyl per 100 kg of plant propagation material is applied to the plant propagation material.

In another embodiment, the invention is directed to methods for controlling or preventing pest damage of plants comprising applying agricultural mixtures of the present invention comprising 3-(difluoromethyl)-1-methyl-N-[(3R)-1,1,3-trimethyl-2,3-dihydroinden-4-yl]pyrazole-4-carboxamide, ethaboxam, and metalaxyl onto a plant propagation material.

In a preferred embodiment, the mixtures of the present invention also contain a neonicotinoid and/or 2-[2-(2,5-dimethylphenoxymethyl)phenyl]-2-methoxy-N-methylacetamide and/or metconazole and/or tolclofos-methyl. In another preferred embodiment, the mixtures of the present invention also contain clothianidin and/or 2-[2-(2,5-dimethylphenoxymethyl)phenyl]-2-methoxy-N-methylacetamide and/or metconazole and/or tolclofos-methyl.

Fungal pathogens include but are not limited to Rhizoctonia, Fusarium, Pythium Phytophthora, Phomopsis, and seed decay fungi including Aspergillus, Penicillium, Alternaria, Rhizopus, and Basidiomycete bunt and smut fungi.

2-[2-(2,5-Dimethylphenoxymethyl)phenyl]-2-methoxy-N-methylacetamide has the following structure and is a fungicide.

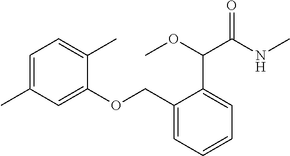

2-[2-(2,5-dimethylphenoxymethyl)phenyl]-2-methoxy-N-methylacetamide

Metconazole, 5-[(4-chlorophenyl)methyl]-2,2-dimethyl-1-(1H-1,2,4-triazol-1-ylmethyl)cyclopentanol, is a conazole fungicide. Metconazole works by inhibiting sterol production in fungal cell metabolism and is effective against Fusarium.

Neonicotinoids are insecticides that bind to nicotinic acetylcholine receptors of a cell. Neonicotinoids that can be used in the present invention include but not limited to clothianidin, imidacloprid, thiamethoxam, acetamiprid, and thiacloprid.

Clothianidin, ((E)-1-(2-chloro-1,3-thiazol-5-ylmethyl)-3-methyl nitroguanidine), (available from Sumitomo Chemical Co., Tokyo, JP) is a member of the nitroguanidine subgroup of neonicotinoid insecticides. Clothianidin attacks the central nervous system of insects and the US Environmental Protection Agency considers clothianidin less harmful to humans, mammals and aquatic animals than organophosphate and carbamate insecticide alternatives. Clothianidin has traditionally been used as a seed treatment to protect seeds from damage caused by chewing and sucking insects.

Thiamethoxam, 3-[(2-Chloro-1,3-thiazol-5-yl)methyl]-5-methyl-N-nitro-1,3,5-oxadiazinan-4-imine, is a neonicotinoid insecticide.

Metalaxyl, N-(2,6-dimethylphenyl)-N-(methoxyacetyl)-aniline methyl ester, is an oomycyte fungicide. Metalaxyl's mode of action involves impacting nucleic acid synthesis affecting RNA polymerase I site in fungi.

As used herein, “mg ai/seed” refers to the milligrams of active ingredient that is applied to the seed. As used herein, “g ai/100 kg seed” refers to the grams of active ingredient that is applied to 100 kg of seeds.

One of skill in the art knows that the seed count per 100 kg of seed can vary based on the size of the seeds. The grams per 100 kg of seed rates provided herein can be adjusted accordingly by one of skill in the art by using simple calculations to determine the appropriate application rate for a given amount of seed per 100 kg of seed. For example, an average seed count of corn per 100 kg of seed is from about 11,000 to 19,000 seeds.

As used herein, “yield” refers to increased crop growth and/or increased biomass.

As used herein, “pest” refers to pathogens and parasites that negatively affect the host plants by colonizing, attacking, irritating, or feeding upon them, or competing for nutrients with the host. A pest may be, for example, an undesirable bacteria, fungus, or insect.

As used herein, “plant” and “plants” refer to wild type and genetically modified members of the plant kingdom, including higher (vascular) plants and lower (non-vascular) plants.

As used herein, “crop plants” refers to cereal, legumes, forage crops, stem and leaf crops, tuber, bulb and root crops, fruit and seed vegetables, fruit and nut crops, beverage crops, oil, fat and wax crops, spices, perfumes and flavorings, and ornamentals, forest and fiber crops.

The mixtures of the present invention may be applied simultaneous or sequentially to the areas in need of treatment.

As used herein, “controlling or preventing pest damage in a growing plant” refers to maintaining the population of the target pest at a rate per plant such that the plant is viable and produces an agriculturally useful product.

As used herein, all numerical values relating to amounts, weights, and the like, that are defined as “about” each particular value is plus or minus 10%. For example, the phrase “about 10% w/w” is to be understood as “9% w/w to 11% w/w.” Therefore, amounts within 10% of the claimed value are encompassed by the scope of the claims.

As used herein “% w/w” and “percent w/w” refer to the percent weight of the total formulation.

As used herein, “DAP” refers to the number of days after planting.

The disclosed embodiments are simply exemplary embodiments of the inventive concepts disclosed herein and should not be considered as limiting, unless the claims expressly state otherwise.

The following examples are intended to illustrate the present invention and to teach one of ordinary skill in the art how to use the formulations of the invention. They are not intended to be limiting in any way.

### EXAMPLES

Below are sources for the compounds used in following examples.

3-(Difluoromethyl)-1-methyl-N-[(3R)-1,1,3-trimethyl-2,3-dihydroinden-4-yl]pyrazole-4-carboxamide is available from Sumitomo Chemical.

2-[2-(2,5-Dimethylphenoxymethyl)phenyl]-2-methoxy-N-methylacetamide, or mandestrobin, is available from Sumitomo Chemical.

Rizolex™, available from Valent USA, contains tolclofos-methyl.

Intego Solo™, available from Valent USA, contains ethaboxam.

Apron®XL®, available from Syngenta (Apron and Apron XL are registered trademarks of Syngenta Corporation), is a metalaxyl formulation.

Maxim®, available from Syngenta (Maxim is a registered trademark of Syngenta Corporation), contains 40% fludioxonil.

Metlock™, available from Valent USA, contains metconazole.

Sebring™, available from NuFarm Americas Inc., contains metalaxyl.

Maxim®Quattro, available from Syngenta (Maxim is a registered trademark of Syngenta Corporation), is a four way mix that contains thiabendazole, metalaxyl-M, fludioxonil and azoxystrobin.

Spirato™, available from NuFarm Americas Inc., is a 40% fludioxonil formulation.

Cruiser®, available from Syngenta (Cruiser is a registered trademark of Syngenta Corporation), is a seed treatment that contains thiamethoxam, a neonicotinoid seed treatment.

Cruiser®Maxx Vibrance Cereals, available from Syngenta (Cruiser is a registered trademark of Syngenta Corporation), is a four way mix containing sedaxane, difenoconazole, mefenoxam, and thiamethoxam.

Prosper™, available from Bayer CropScience, is a four way mix containing 9.5% clothianidin, 9.5% thiram (tetramethylthiuram disulfide), 4.4% carboxin (5,6-dihydro-2-methyl-N-phenyl-1,4-oxathiin-3-carboxamide), and 0.32% metalaxyl.

ConcepIII, available from Syngenta, contains 74% fluxofenin.

Stamina™, available from BASF Corporation, contains pyraclostrobin.

Helix®XTra, available from Syngenta (Helix is a registered trademark of Syngenta Corporation), is a four way mix containing 21% thiamthoxam, 1.25% difenoconazole, 0.39% metalaxyl-M and S-isomer, and 0.13% fludioxonil.

Release®, available from Valent BioSciences Corporation (Release is a registered trademark of Valent BioSciences Corporation), is a 10% gibberellic acid formulation.

SorPro™, available from NuFarm Americas Inc., contains 74% fluxofenim, which is an herbicide seed safener.

### Example 1

### Corn Emergence, Vigor and Pest Infestation Study

A study was conducted in order to determine the effects of 3-(difluoromethyl)-1-methyl-N-[(3R)-1,1,3-trimethyl-2,3-dihydroinden-4-yl]pyrazole-4-carboxamide mixtures on corn plant stand, vigor and the effects of pest infestation. The formulated actives were tank mixed in a seed treatment slurry. An aliquot of the tank mix was applied to seeds using a Hege 11 treater (manufactured by Winterstieger GmbH). The tank mix was injected through a nozzle or onto a rotating disk that atomizes the formulation and applies it to the seeds. The seeds fall into or flow into a rotating drum. The rotation spreads and then dries the formulation on the seeds.

Two separate trials/plantings were completed in April about two weeks apart. Randomized block design was used and the field was inoculated with Rhizoctonia. Emergence is the number of plants per acre, vigor was rated on a scale of 1 to 9, pest severity was the percentage of infected plants, and pest incidence was rated on a scale of 1 to 9. The plant emergence, vigor, pest severity and pest incidence were taken about 30 DAP. Final yield was taken about six months after planting. The results of these studies can be seen below in Tables 1A and 1B.

TABLE 1A
Corn Plant Emergence, Plant Vigor, Pest Severity, Pest Incidence, and Plant
Yield for First Planting

| | Application | | | | | |
|---|---|---|---|---|---|---|
| | Rate | Plant | Plant | Pest | Pest | Plant Yield |
| Treatment Actives | (mg ai/seed) | Emergence | Vigor | Severity | Incidence | (Bu/A) |
| Thiamethoxam | 0.25 | 19800 | 4.0 | 41.3 | 3.8 | 60.8 |
| Metalaxyl+ | 0.008 | 24300 | 5.8 | 22.5 | 4.8 | 70.6 |
| Metconazole+ | 0.004 | | | | | |
| Ethaboxam | 0.25 | | | | | |
| Metalaxyl+ | 0.008 | 25450 | 5.8 | 20.0 | 5.3 | |
| Fungicide+ | 0.028 | | | | | |
| Ethaboxam | 0.25 | | | | | |
| Metalaxyl+ | 0.008 | 27425 | 6.8 | 12.5 | 7.3 | |
| Pyraclostrobin+ | 0.004 | | | | | |
| Ethaboxam | 0.25 | | | | | |
| Metalaxyl+ | 0.008 | 27625 | 7.3 | 8.8 | 7.0 | 75.9 |
| Fludioxonil+ | 0.007 | | | | | |
| Ethaboxam | 0.25 | | | | | |
| (Commercial STD) | | | | | | |
| Metalaxyl+ | 0.008 | 25700 | 5.8 | 21.3 | 6.8 | |
| 3-(Difluoromethyl)- | 0.003 | | | | | |
| 1-methyl-N-[(3R)- | 0.25 | | | | | |
| 1,1,3-trimethyl-2,3- | | | | | | |
| dihydroinden-4- | | | | | | |
| yl]pyrazole-4- | | | | | | |
| carboxamide+ | | | | | | |
| Ethaboxam | | | | | | |
| Metalaxyl+ | 0.008 | 27525 | 7.0 | 11.3 | 7.5 | |
| 3-(Difluoromethyl)- | 0.014 | | | | | |
| 1-methyl-N-[(3R)- | 0.25 | | | | | |
| 1,1,3-trimethyl-2,3- | | | | | | |
| dihydroinden-4- | | | | | | |
| yl]pyrazole-4- | | | | | | |
| carboxamide+ | | | | | | |
| Ethaboxam | | | | | | |
| Metalaxyl+ | 0.008 | 29150 | 8.0 | 6.3 | 8.3 | 79.2 |
| 3-(Difluoromethyl)- | 0.03 | | | | | |
| 1-methyl-N-[(3R)- | 0.25 | | | | | |
| 1,1,3-trimethyl-2,3- | | | | | | |
| dihydroinden-4- | | | | | | |
| yl]pyrazole-4- | | | | | | |
| carboxamide+ | | | | | | |
| Ethaboxam | | | | | | |
| Metalaxyl+ | 0.008 | 30750 | 9.0 | 3.8 | 8.8 | 81.3 |
| 3-(Difluoromethyl)- | 0.03 | | | | | |
| 1-methyl-N-[(3R)- | 0.004 | | | | | |
| 1,1,3-trimethyl-2,3- | 0.25 | | | | | |
| dihydroinden-4- | | | | | | |
| yl]pyrazole-4- | | | | | | |
| carboxamide+ | | | | | | |
| Metconazole+ | | | | | | |
| Ethaboxam | | | | | | |

TABLE 1B
Corn Plant Emergence, Plant Vigor, Pest Severity, Pest Incidence, and
Plant Yield for Second Planting

| | Application | | | | | |
|---|---|---|---|---|---|---|
| | Rate | Plant | Plant | Pest | Pest | Plant Yield |
| Treatment Actives | (mg ai/seed) | Emergence | Vigor | Severity | Incidence | (Bu/A) |
| Thiamethoxam | 0.25 | 25450 | 5.5 | 16.3 | 6.5 | 106.7 |
| Metalaxyl+ | 0.008 | 26400 | 6.5 | 13.8 | 6.8 | 110.1 |
| Metconazole+ | 0.004 | | | | | |
| Ethaboxam | 0.25 | | | | | |
| Metalaxyl+ | 0.008 | 27075 | 7.5 | 12.5 | 7.5 | |
| Fungicide+ | 0.028 | | | | | |
| Ethaboxam | 0.25 | | | | | |
| Metalaxyl+ | 0.008 | 30650 | 8.3 | 8.8 | 8.3 | |
| Pyraclostrobin+ | 0.004 | | | | | |
| Ethaboxam | 0.25 | | | | | |
| Metalaxyl+ | 0.008 | 30850 | 8.5 | 7.5 | 8.5 | 125.5 |
| Fludioxonil+ | 0.007 | | | | | |
| Ethaboxam | 0.25 | | | | | |
| (Commercial STD) | | | | | | |
| Metalaxyl+ | 0.008 | 27100 | 7.3 | 13.8 | 7.0 | |
| 3-(Difluoromethyl)- | 0.003 | | | | | |
| 1-methyl-N-[(3R)- | 0.25 | | | | | |
| 1,1,3-trimethyl-2,3- | | | | | | |
| dihydroinden-4- | | | | | | |
| yl]pyrazole-4- | | | | | | |
| carboxamide+ | | | | | | |
| Ethaboxam | | | | | | |
| Metalaxyl+ | 0.008 | 30250 | 8.3 | 8.8 | 8.3 | |
| 3-(Difluoromethyl)- | 0.014 | | | | | |
| 1-methyl-N-[(3R)- | 0.25 | | | | | |
| 1,1,3-trimethyl-2,3- | | | | | | |
| dihydroinden-4- | | | | | | |
| yl]pyrazole-4- | | | | | | |
| carboxamide+ | | | | | | |
| Ethaboxam | | | | | | |
| Metalaxyl+ | 0.008 | 31400 | 8.8 | 5.0 | 9.0 | 129.1 |
| 3-(Difluoromethyl)- | 0.03 | | | | | |
| 1-methyl-N-[(3R)- | 0.25 | | | | | |
| 1,1,3-trimethyl-2,3- | | | | | | |
| dihydroinden-4- | | | | | | |
| yl]pyrazole-4- | | | | | | |
| carboxamide+ | | | | | | |
| Ethaboxam | | | | | | |
| Metalaxyl+ | 0.008 | 31725 | 9.0 | 3.8 | 9.0 | 132.2 |
| 3-(Difluoromethyl)- | 0.03 | | | | | |
| 1-methyl-N-[(3R)- | 0.004 | | | | | |
| 1,1,3-trimethyl-2,3- | 0.25 | | | | | |
| dihydroinden-4- | | | | | | |
| yl]pyrazole-4- | | | | | | |
| carboxamide+ | | | | | | |
| Metconazole+ | | | | | | |
| Ethaboxam | | | | | | |

There was no phytotoxicity observed during this study by any of the treatments. This study illustrates that 3-(difluoromethyl)-1-methyl-N-[(3R)-1,1,3-trimethyl-2,3-dihydroinden-4-yl]pyrazole-4-carboxamide mixture treatments provide healthier plants than other treatments.

The mixtures of the present invention also provided dramatic increases in yield. This allows for more corn to be produced from the same amount of land.

### Example 2

### Corn Plant Stand Establishment and Yield Study

A study was conducted in order to determine the effects of seed treatments on the number of corn plants per acre and yield. One acre was planted with seeds treated as indicated below in a randomized block design. Treatments were applied to the seeds in a manner known by those of skill in the art. The number of plants was determined for each treatment on four different days before harvest. After harvest, the yield of the plants was determined. The results of this study can be seen below in Tables 2 and 3.

TABLE 2
Corn Plant Stand-Number of Plants Per Acre

| | Application | | |
|---|---|---|---|
| | Rate | | |
| | (mg | | |
| | active[s] | | |
| | per | 34 | 116 |
| Treatment and Actives | seed) | DAP | DAP |
| Thiamethoxam | 0.250 | 22052 | 20010 |
| Ethaboxam + | 0.014 | 24842 | 22869 |
| Metalaxyl + | 0.003 | | |
| Thiamethoxam | 0.250 | | |
| Commercial 4 way mix (Thiabendazole, | 0.064 | 27021 | 21984 |
| Metalaxyl-M, Fludioxonil and | 0.250 | | |
| Azoxystrobin) + | | | |
| Thiamethoxam | | | |
| Metconazole + | 0.004 | 26340 | 23754 |
| 2-[2-(2,5- | 0.017 | | |
| Dimethylphenoxymethyl)phenyl]-2- | 0.014 | | |
| methoxy-N-methylacetamide + | 0.003 | | |
| Ethaboxam + | 0.250 | | |
| Metalaxyl + | | | |
| Thiamethoxam | | | |
| 3-(Difluoromethyl)-1-methyl-N-[(3R)- | 0.014 | 20350 | 20147 |
| 1,1,3-trimethyl-2,3-dihydroinden-4- | 0.014 | | |
| yl]pyrazole-4-carboxamide + | 0.003 | | |
| Ethaboxam + | 0.250 | | |
| Metalaxyl + | | | |
| Thiamethoxam | | | |
| 3-(Difluoromethyl)-1-methyl-N-[(3R)- | 0.014 | 27770 | 22937 |
| 1,1,3-trimethyl-2,3-dihydroinden-4- | 0.004 | | |
| yl]pyrazole-4-carboxamide + | 0.014 | | |
| Metconazole + | 0.003 | | |
| Ethaboxam + | 0.250 | | |
| Metalaxyl + | | | |
| Thiamethoxam | | | |
| 3-(Difluoromethyl)-1-methyl-N-[(3R)- | 0.014 | 26817 | 22664 |
| 1,1,3-trimethyl-2,3-dihydroinden-4- | 0.017 | | |
| yl]pyrazole-4-carboxamide + | 0.014 | | |
| 2-[2-(2,5- | 0.003 | | |
| dimethylphenoxymethyl)phenyl]-2- | 0.250 | | |
| methoxy-N-methylacetamide + | | | |
| Ethaboxam + | | | |
| Metalaxyl + | | | |
| Thiamethoxam | | | |
| 3-(Difluoromethyl)-1-methyl-N-[(3R)- | 0.014 | 25728 | 21304 |
| 1,1,3-trimethyl-2,3-dihydroinden-4- | 0.004 | | |
| yl]pyrazole-4-carboxamide + | 0.017 | | |
| Metconazole + | 0.014 | | |
| 2-[2-(2,5- | 0.003 | | |
| Dimethylphenoxymethyl)phenyl]-2- | 0.250 | | |
| methoxy-N-methylacetamide + | | | |
| Ethaboxam + | | | |
| Metalaxyl + | | | |
| Thiamethoxam | | | |
| Metconazole + | 0.004 | 24843 | 21236 |
| Ethaboxam + | 0.014 | | |
| Metalaxyl + | 0.003 | | |
| Thiamthoxam | 0.250 | | |

TABLE 3
Corn Yield

| | | Rate (mg | Bushels |
|---|---|---|---|
| | | active[s] | Per |
| Treatment | Actives | per seed) | Acre |
| 1 | Thiamethoxam | 0.250 | 134 |
| 2 | Ethaboxam + | 0.014 | 140 |
| | Metalaxyl + | 0.003 | |
| | Thiamethoxam | 0.250 | |
| 3 | Commercial 4 way mix | 0.064 | 139 |
| | (Thiabendazole, | 0.250 | |
| | Metalaxyl-M, | | |
| | Fludioxonil and Azoxystrobin) + | | |
| | Thiamethoxam | | |
| 4 | Metconazole + | 0.004 | 148 |
| | 2-[2-(2,5- | 0.017 | |
| | Dimethylphenoxymethyl)phenyl]- | 0.014 | |
| | 2-methoxy-N-methylacetamide + | 0.003 | |
| | Ethaboxam + | 0.250 | |
| | Metalaxyl + | | |
| | Thiamethoxam | | |
| 5 | 3-(Difluoromethyl)-1-methyl- | 0.014 | 128 |
| | N-[(3R)-1,1, | 0.014 | |
| | 3-trimethyl-2,3-dihydroinden- | 0.003 | |
| | 4-yl]pyrazole- | 0.250 | |
| | 4-carboxamide + | | |
| | Ethaboxam + | | |
| | Metalaxyl + | | |
| | Thiamethoxam | | |
| 6 | 3-(Difluoromethyl)-1-methyl- | 0.014 | 141 |
| | N-[(3R)-1,1,3- | 0.004 | |
| | trimethyl-2,3-dihydroinden- | 0.014 | |
| | 4-yl]pyrazole-4- | 0.003 | |
| | carboxamide + | 0.250 | |
| | Metconazole + | | |
| | Ethaboxam + | | |
| | Metalaxyl + | | |
| | Thiamethoxam | | |
| 7 | 3-(Difluoromethyl)-1-methyl- | 0.014 | 146 |
| | N-[(3R)-1,1,3- | 0.017 | |
| | trimethyl-2,3-dihydroinden- | 0.014 | |
| | 4-yl]pyrazole-4- | 0.003 | |
| | carboxamide + | 0.250 | |
| | 2-[2-(2,5- | | |
| | dimethylphenoxymethyl)phenyl]-2- | | |
| | methoxy-N-methylacetamide + | | |
| | Ethaboxam + | | |
| | Metalaxyl + | | |
| | Thiamethoxam | | |
| 8 | 3-(Difluoromethyl)-1-methyl- | 0.014 | 132 |
| | N-[(3R)-1,1,3- | 0.004 | |
| | trimethyl-2,3-dihydroinden- | 0.017 | |
| | 4-yl]pyrazole-4- | 0.014 | |
| | carboxamide + | 0.003 | |
| | Metconazole + | 0.250 | |
| | 2-[2-(2,5- | | |
| | Dimethylphenoxymethyl)phenyl]-2- | | |
| | methoxy-N-methylacetamide + | | |
| | Ethaboxam + | | |
| | Metalaxyl + | | |
| | Thiamethoxam | | |
| 9 | Metconazole + | 0.004 | 143 |
| | Ethaboxam + | 0.014 | |
| | Metalaxyl + | 0.003 | |
| | Thiamthoxam | 0.250 | |

This study illustrates a 3-(difluoromethyl)-1-methyl-N-[(3R)-1,1,3-trimethyl-2,3-dihydroinden-4-yl]pyrazole-4-carboxamide mixture with metconazole, ethaboxam, metalaxyl, and thiamethoxam provides better stand than the commercial standard four-way mixture with an insecticidal control (compare Treatment 6 with Treatment 3). 3-(Difluoromethyl)-1-methyl-N-[(3R)-1,1,3-trimethyl-2,3-dihydroinden-4-yl]pyrazole-4-carboxamide mixtures also lead to higher yields. Thiamethoxam does not have activity against fungal pathogens.

### Example 3

### Another Corn Plant Stand Establishment and Yield Study

Another study was conducted in order to determine the effects of seed treatments on the number of corn plants per acre and yield. The study design was the same as the study described in Example 1. The results of this study can be seen below in Tables 3 and 4.

TABLE 4
Corn Plant Stand-Number of Plants Per Acre

| | | Rate | | | |
|---|---|---|---|---|---|
| | | (mg active[s] | May 20 | May 27 | June 12 |
| Treatment | Actives | per seed) | 7 DAP | 14 DAP | 28 DAP |
| 1 | Thiamethoxam | 0.250 | 30318 | 31450 | 31538 |
| 2 | Ethaboxam + | 0.014 | 29969 | 31537 | 31363 |
| | Metalaxyl + | 0.003 | | | |
| | Thiamethoxam | 0.250 | | | |
| 3 | Commercial 4 way mix | 0.064 | 31451 | 31799 | 31799 |
| | (Thiabendazole, Metalaxyl-M, | 0.250 | | | |
| | Fludioxonil and Azoxystrobin) + | | | | |
| | Thiamethoxam | | | | |
| 4 | Metconazole + | 0.004 | 30666 | 31276 | 30928 |
| | 2-[2-(2,5- | 0.017 | | | |
| | Dimethylphenoxymethyl)phenyl]- | 0.014 | | | |
| | 2-methoxy-N-methylacetamide + | 0.003 | | | |
| | Ethaboxam + | 0.250 | | | |
| | Metalaxyl + | | | | |
| | Thiamethoxam | | | | |
| 5 | 3-(Difluoromethyl)-1-methyl-N- | 0.014 | 30840 | 31799 | 31886 |
| | [(3R)-1,1,3-trimethyl-2,3- | 0.014 | | | |
| | dihydroinden-4-yl]pyrazole-4- | 0.003 | | | |
| | carboxamide + | 0.250 | | | |
| | Ethaboxam + | | | | |
| | Metalaxyl + | | | | |
| | Thiamethoxam | | | | |
| 6 | 3-(Difluoromethyl)-1-methyl-N- | 0.014 | 31799 | 32147 | 32147 |
| | [(3R)-1,1,3-trimethyl-2,3- | 0.004 | | | |
| | dihydroinden-4-yl]pyrazole-4- | 0.014 | | | |
| | carboxamide + | 0.003 | | | |
| | Metconazole + | 0.250 | | | |
| | Ethaboxam + | | | | |
| | Metalaxyl + | | | | |
| | Thiamethoxam | | | | |
| 7 | 3-(Difluoromethyl)-1-methyl-N- | 0.014 | 32931 | 33105 | 32931 |
| | [(3R)-1,1,3-trimethyl-2,3- | 0.017 | | | |
| | dihydroinden-4-yl]pyrazole-4- | 0.014 | | | |
| | carboxamide + | 0.003 | | | |
| | 2-[2-(2,5- | 0.250 | | | |
| | Dimethylphenoxymethyl)phenyl]- | | | | |
| | 2-methoxy-N-methylacetamide + | | | | |
| | Ethaboxam + | | | | |
| | Metalaxyl + | | | | |
| | Thiamethoxam | | | | |
| 8 | 3-(Difluoromethyl)-1-methyl-N- | 0.014 | 31363 | 31799 | 31625 |
| | [(3R)-1,1,3-trimethyl-2,3- | 0.004 | | | |
| | dihydroinden-4-yl]pyrazole-4- | 0.017 | | | |
| | carboxamide + | 0.014 | | | |
| | Metconazole + | 0.003 | | | |
| | 2-[2-(2,5- | 0.250 | | | |
| | Dimethylphenoxymethyl)phenyl]- | | | | |
| | 2-methoxy-N-methylacetamide + | | | | |
| | Ethaboxam + | | | | |
| | Metalaxyl + | | | | |
| | Thiamethoxam | | | | |
| 9 | Metconazole + | 0.004 | 31537 | 31712 | 31712 |
| | Ethaboxam + | 0.014 | | | |
| | Metalaxyl + | 0.003 | | | |
| | Thiamethoxam | 0.250 | | | |

TABLE 5
Corn Plant Yield

| | | Rate (mg | |
|---|---|---|---|
| | | active[s] | Bushels/ |
| Treatment | Actives | per seed) | Acre |
| 1 | Thiamethoxam | 0.250 | 172 |
| 2 | Ethaboxam + | 0.014 | 171 |
| | Metalaxyl + | 0.003 | |
| | Thiamethoxam | 0.250 | |
| 3 | Commercial 4 way mix (Thiabendazole, | 0.064 | 173 |
| | Metalaxyl-M, Fludioxonil and | 0.250 | |
| | Azoxystrobin) + | | |
| | Thiamethoxam | | |
| 4 | Metconazole + | 0.004 | 163 |
| | 2-[2-(2,5- | 0.017 | |
| | Dimethylphenoxymethyl)phenyl]-2- | 0.014 | |
| | methoxy-N-methylacetamide + | 0.003 | |
| | Ethaboxam + | 0.250 | |
| | Metalaxyl + | | |
| | Thiamethoxam | | |
| 5 | 3-(Difluoromethyl)-1-methyl-N-[(3R)- | 0.014 | 176 |
| | 1,1,3-trimethyl-2,3-dihydroinden-4- | 0.014 | |
| | yl]pyrazole-4-carboxamide + | 0.003 | |
| | Ethaboxam + | 0.250 | |
| | Metalaxyl + | | |
| | Thiamethoxam | | |
| 6 | 3-(Difluoromethyl)-1-methyl-N-[(3R)- | 0.014 | 184 |
| | 1,1,3-trimethyl-2,3-dihydroinden-4- | 0.004 | |
| | yl]pyrazole-4-carboxamide + | 0.014 | |
| | Metconazole + | 0.003 | |
| | Ethaboxam + | 0.250 | |
| | Metalaxyl + | | |
| | Thiamethoxam | | |
| 7 | 3-(Difluoromethyl)-1-methyl-N-[(3R)- | 0.014 | 170 |
| | 1,1,3-trimethyl-2,3-dihydroinden-4- | 0.017 | |
| | yl]pyrazole-4-carboxamide + | 0.014 | |
| | 2-[2-(2,5- | 0.003 | |
| | dimethylphenoxymethyl)phenyl]-2- | 0.250 | |
| | methoxy-N-methylacetamide + | | |
| | Ethaboxam + | | |
| | Metalaxyl + | | |
| | Thiamethoxam | | |
| 8 | 3-(Difluoromethyl)-1-methyl-N-[(3R)- | 0.014 | 180 |
| | 1,1,3-trimethyl-2,3-dihydroinden-4- | 0.004 | |
| | yl]pyrazole-4-carboxamide + | 0.017 | |
| | Metconazole + | 0.014 | |
| | 2-[2-(2,5- | 0.003 | |
| | dimethylphenoxymethyl)phenyl]-2- | 0.250 | |
| | methoxy-N-methylacetamide + | | |
| | Ethaboxam + | | |
| | Metalaxyl + | | |
| | Thiamethoxam | | |
| 9 | Metconazole + | 0.004 | 172 |
| | Ethaboxam + | 0.014 | |
| | Metalaxyl + | 0.003 | |
| | Thiamethoxam | 0.250 | |

This study illustrates that a mixture of 3-(difluoromethyl)-1-methyl-N-[(3R)-1,1,3-trimethyl-2,3-dihydroinden-4-yl]pyrazole-4-carboxamide with ethab oxam, metalaxyl, and thiamethoxam (Treatment 5) provides increased stand. The addition of metconazole or mandestrobin further increases stand (Treatments 6 and 7). However, if both metconazole and mandestrobin are added to Treatment 5, no additional increase is seen over Treatment 5 (Treatment 8). Regarding yield, 3-(difluoromethyl)-1-methyl-N-[(3R)-1,1,3-trimethyl-2,3-dihydroinden-4-yl]pyrazole-4-carboxamide mixed with metconazole resulted in the greatest increases (Treatment 6 with 184 bushels and Treatment 8 with 180 bushels compared to insecticide check with 172 bushels and commercial standard with 173 bushels).

### Example 4

### Soybean Vigor and Health, Infestation and Yield Study

A study was conducted in order to determine the effects of seed treatments on the vigor and health of soybean plants, percentage of pest infestation, and yield. Treatments were applied to the seeds in a manner known by those of skill in the art. Pest incidence is percent of the plants infected with Fusarium. The results of this study can be seen below in Table 6.

TABLE 6
Soybean Height, Pest Incidence, and Yield

| | | Rate | Plant | | |
|---|---|---|---|---|---|
| | | (mg active[s] | Height | Pest | |
| Treatment | Actives | per seed) | in cm | incidence | Yield |
| 1 | Untreated | N/A | 15.9 | 32.5 | 45.0 |
| 2 | Commercial 4 way mix | 0.092 | 13.9 | 20.0 | 47.0 |
| | (Ipconazole, Ethaboxam, | 0.012 | | | |
| | Metalaxyl, and Clothianidin) + | | | | |
| | Ethaboxam | | | | |
| 3 | 3-(Difluoromethyl)-1-methyl-N- | 0.004 | 14.8 | 17.5 | 58.9 |
| | [(3R)-1,1,3-trimethyl-2,3- | 0.012 | | | |
| | dihydroinden-4-yl]pyrazole-4- | 0.003 | | | |
| | carboxamide + | 0.081 | | | |
| | Ethaboxam + | | | | |
| | Metalaxyl + | | | | |
| | Clothianidin | | | | |
| 4 | 3-(Difluoromethyl)-1-methyl-N- | 0.008 | 15.8 | 12.5 | 55.9 |
| | [(3R)-1,1,3-trimethyl-2,3- | 0.012 | | | |
| | dihydroinden-4-yl]pyrazole-4- | 0.003 | | | |
| | carboxamide + | 0.081 | | | |
| | Ethaboxam + | | | | |
| | Metalaxyl + | | | | |
| | Clothianidin | | | | |
| 5 | 3-(Difluoromethyl)-1-methyl-N- | 0.004 | 17.2 | 15.0 | 57.1 |
| | [(3R)-1,1,3-trimethyl-2,3- | 0.016 | | | |
| | dihydroinden-4-yl]pyrazole-4- | 0.012 | | | |
| | carboxamide + | 0.003 | | | |
| | Tolclofos-methyl + | 0.081 | | | |
| | Ethaboxam + | | | | |
| | Metalaxyl + | | | | |
| | Clothianidin | | | | |
| 6 | 3-(Difluoromethyl)-1-methyl-N- | 0.004 | 15.8 | 13.8 | 61.3 |
| | [(3R)-1,1,3-trimethyl-2,3- | 0.016 | | | |
| | dihydroinden-4-yl]pyrazole-4- | 0.012 | | | |
| | carboxamide + | 0.003 | | | |
| | 2-[2-(2,5- | 0.081 | | | |
| | dimethylphenoxymethyl)phenyl]- | | | | |
| | 2-methoxy-N-methylacetamide + | | | | |
| | Ethaboxam + | | | | |
| | Metalaxyl + | | | | |
| | Clothianidin | | | | |
| 7 | 3-(Difluoromethyl)-1-methyl-N- | 0.004 | 16.7 | 15 | 57.2 |
| | [(3R)-1,1,3-trimethyl-2,3- | 0.008 | | | |
| | dihydroinden-4-yl]pyrazole-4- | 0.008 | | | |
| | carboxamide + | 0.012 | | | |
| | 2-[2-(2,5- | 0.003 | | | |
| | dimethylphenoxymethyl)phenyl]- | 0.081 | | | |
| | 2-methoxy-N-methylacetamide + | | | | |
| | Tolclofos-methyl + | | | | |
| | Ethaboxam + | | | | |
| | Metalaxyl + | | | | |
| | Clothianidin | | | | |

This study illustrates that a 3-(difluoromethyl)-1-methyl-N-[(3R)-1,1,3-trimethyl-2,3-dihydroinden-4-yl]pyrazole-4-carboxamide mixture treatment increases plant height and yield compared to the untreated control and commercial standard (for example, compare Treatment 6 with the commercial standard Treatment 2).

### Example 4

### Rice Yield Study

A study was conducted to determine the effect seed treatments had on rice yield. The rice was inoculated with Rhizoctonia in a manner to provide extreme disease pressure on the crop. The results of this study can be seen below in Table 9.

TABLE 9
Rice Yield-Bushels per Acre

| | | Rate (g ai/100 kg | Yield |
|---|---|---|---|
| Treatment | Actives | seed) | (Bu/A) |
| 1 | Clothianidin + | 50 | 14.9 |
| | Gibberellic acid | 1.0 | |
| 2 | Fludioxonil + | 2.5 | 26.3 |
| | Metalaxyl + | 8.0 | |
| | Clothianidin + | 50 | |
| | Gibberellic acid | 1.0 | |
| 3 | Fludioxonil + | 2.5 | 44.3 |
| | Metalaxyl + | 8.0 | |
| | Clothianidin + | 50 | |
| | Gibberellic acid | 1.0 | |
| 4 | Fludioxonil + | 1.5 | 38.5 |
| | Mefenoxam + | 8.75 | |
| | Azoxystrobin + | 7.1 | |
| | Thiamethoxam | 140 | |
| | (Commercial STD) | | |
| 5 | 3-(Difluoromethyl)-1-methyl- | 5.0 | 106.8 |
| | N-[(3R)-1,1,3-trimethyl-2,3- | 8.0 | |
| | dihydroinden-4-yl]pyrazole-4- | 50 | |
| | carboxamide + | 1.0 | |
| | Metalaxyl + | | |
| | Clothianidin + | | |
| | Gibberellic acid | | |
| 6 | 3-(Difluoromethyl)-1-methyl- | 5.0 | 128.2 |
| | N-[(3R)-1,1,3-trimethyl-2,3- | 2.5 | |
| | dihydroinden-4-yl]pyrazole-4- | 8.0 | |
| | carboxamide + | 50 | |
| | Fludioxonil + | 1.0 | |
| | Metalaxyl + | | |
| | Clothianidin + | | |
| | Gibberellic acid | | |

As illustrated by Table 9, the mixtures containing 3-(difluoromethyl)-1-methyl-N-[(3R)-1,1,3-trimethyl-2,3-dihydroinden-4-yl]pyrazole-4-carboxamide provided at least twice the yield (2.8 for Treatment 5 and 3.3 for Treatment 6) as the commercial standard, Treatment 4. The addition of fludioxonil to 3-(difluoromethyl)-1-methyl-N-[(3R)-1,1,3-trimethyl-2,3-dihydroinden-4-yl]pyrazole-4-carboxamide provides a broader spectrum of activity with the addition of Fusarium protection.

### Example 5

### Canola Stand and Yield Study

A study was conducted to determine the effect seed treatments had on canola stand and yield. The canola was inoculated with Rhizoctonia. The results of this study can be seen below in Table 10.

TABLE 10
Canola Stand and Yield

| | | Rate (g | Stand/2 | Yield |
|---|---|---|---|---|
| | | ai/100 | Meter | (KG/ |
| Treatment | Actives | kg seed) | Row | Hectare) |
| 1 | Untreated Control | N/A | 9.75 | 1901 |
| 2 | Commercial 4 way mix | 400 | 3.75 | 1398 |
| | (Thiamethoxam + | 24 | | |
| | Difenoconazole + | 7.2 | | |
| | Mefenoxam + | 1.8 | | |
| | Fludioxonil) | | | |
| 3 | Commercial 4 way mix | 400 | 6.75 | 1607 |
| | (Clothianidin + | 15 | | |
| | Penflufen + | 10 | | |
| | Trifloxystrobin + | 10 | | |
| | Metalaxyl) | | | |
| 4 | 3-(Difluoromethyl)-1-methyl-N- | 5.0 | 9.25 | 1718 |
| | [(3R)-1,1,3-trimethyl-2,3- | 7.5 | | |
| | dihydroinden-4-yl]pyrazole-4- | 2.0 | | |
| | carboxamide + | 400 | | |
| | Ethaboxam + | | | |
| | Metalaxyl + | | | |
| | Clothianidin | | | |
| 5 | Metconazole + | 1.5 | 4.25 | 1398 |
| | 3-(Difluoromethyl)-1-methyl-N- | 5.0 | | |
| | [(3R)-1,1,3-trimethyl-2,3- | 7.5 | | |
| | dihydroinden-4-yl]pyrazole-4- | 2.0 | | |
| | carboxamide + | 400 | | |
| | Ethaboxam + | | | |
| | Metalaxyl + | | | |
| | Clothianidin | | | |
| 6 | Metconazole + | 1.5 | 4.75 | 1392 |
| | 2-[2-(2,5- | 10 | | |
| | dimethylphenoxymethyl)phenyl]- | 7.5 | | |
| | 2-methoxy-N-methylacetamide + | 2.0 | | |
| | Ethaboxam + | 400 | | |
| | Metalaxyl + | | | |
| | Clothianidin | | | |
| 7 | Metconazole + | 1.5 | 16.25 | 2007 |
| | 3-(Difluoromethyl)-1-methyl-N- | 5.0 | | |
| | [(3R)-1,1,3-trimethyl-2,3- | 10 | | |
| | dihydroinden-4-yl]pyrazole-4- | 7.5 | | |
| | carboxamide + | 2.0 | | |
| | 2-[2-(2,5- | 400 | | |
| | dimethylphenoxymethyl)phenyl]- | | | |
| | 2-methoxy-N-methylacetamide + | | | |
| | Ethaboxam + | | | |
| | Metalaxyl + | | | |
| | Clothianidin | | | |
| 8 | 3-(Difluoromethyl)-1-methyl-N- | 5.0 | 13.7 | 1685 |
| | [(3R)-1,1,3-trimethyl-2,3- | 10 | | |
| | dihydroinden-4-yl]pyrazole-4- | 7.5 | | |
| | carboxamide + | 2.0 | | |
| | 2-[2-(2,5- | 400 | | |
| | dimethylphenoxymethyl)phenyl]- | | | |
| | 2-methoxy-N-methylacetamide + | | | |
| | Ethaboxam + | | | |
| | Metalaxyl + | | | |
| | Clothianidin | | | |

This study shows that a treatment which includes 3-(difluoromethyl)-1-methyl-N-[(3R)-1,1,3-trimethyl-2,3-dihydroinden-4-yl]pyrazole-4-carboxamide, metalaxyl, and ethaboxam with metconazole, clothianidin and 2-[2-(2,5-dimethylphenoxymethyl)phenyl]-2-methoxy-N-methylacetamide provides increased yield compared to the untreated control (compare Treatment 1 with Treatment 7).

### Example 6

### Sorghum Yield Study

A study was conducted to determine the effects of 3-(difluoromethyl)-1-methyl-N-[(3R)-1,1,3-trimethyl-2,3-dihydroinden-4-yl]pyrazole-4-carboxamide mixtures on sorghum yield. Treatments were applied to the seeds in a manner known by those of skill in the art. The results of this study can be seen below in Table 11.

TABLE 11
Sorghum Yield

| | | Rate (g ai/100 | |
|---|---|---|---|
| Treatment | Actives | kg seed) | Yield |
| 1 | Clothianidin + | 200 | 132.8 |
| | Fluxofenim | 39 | |
| 2 | Ethaboxam + | 5 | 145.0 |
| | Metalaxyl + | 8 | |
| | Clothianidin + | 200 | |
| | Fluxofenim | 39 | |
| 3 | Fludioxonil + | 2.5 | 134.6 |
| | Mefenoxam + | 7.5 | |
| | Thiamethoxam + | 200 | |
| | Fluxofenin | 39 | |
| 4 | Tolclofos-methyl + | 10 | 139.0 |
| | 2-[2-(2,5- | 10 | |
| | dimethylphenoxymethyl)phenyl]- | 5 | |
| | 2-methoxy-N-methylacetamide + | 8 | |
| | Ethaboxam + | 200 | |
| | Metalaxyl + | 39 | |
| | Clothianidin + | | |
| | Fluxofenim | | |
| 5 | 3-(Difluoromethyl)-1-methyl-N- | 5 | 130.2 |
| | [(3R)-1,1,3-trimethyl-2,3- | 5 | |
| | dihydroinden-4-yl]pyrazole-4- | 8 | |
| | carboxamide + | 200 | |
| | Ethaboxam + | 39 | |
| | Metalaxyl + | | |
| | Clothianidin + | | |
| | Fluxofenim | | |
| 6 | 3-(Difluoromethyl)-1-methyl-N- | 5 | 146.6 |
| | [(3R)-1,1,3-trimethyl-2,3- | 10 | |
| | dihydroinden-4-yl]pyrazole-4- | 5 | |
| | carboxamide + | 8 | |
| | Tolclofos-methyl + | 200 | |
| | Ethaboxam + | 39 | |
| | Metalaxyl + | | |
| | Clothianidin + | | |
| | Fluxofenim | | |
| 7 | 3-(Difluoromethyl)-1-methyl-N- | 5 | 131.2 |
| | [(3R)-1,1,3-trimethyl-2,3- | 10 | |
| | dihydroinden-4-yl]pyrazole-4- | 5 | |
| | carboxamide + | 8 | |
| | 2-[2-(2,5- | 200 | |
| | dimethylphenoxymethyl)phenyl]- | 39 | |
| | 2-methoxy-N-methylacetamide + | | |
| | Ethaboxam + | | |
| | Metalaxyl + | | |
| | Clothianidin + | | |
| | Fluxofenim | | |
| 8 | 3-(Difluoromethyl)-1-methyl-N- | 5 | 149.2 |
| | [(3R)-1,1,3-trimethyl-2,3- | 10 | |
| | dihydroinden-4-yl]pyrazole-4- | 5 | |
| | carboxamide + | 8 | |
| | Tolclofos-methyl + | 200 | |
| | Ethaboxam + | 39 | |
| | Metalaxyl + | | |
| | Clothianidin + | | |
| | Fluxofenim | | |

This study illustrates that the addition of tolclofos-methyl to 3-(difluoromethyl)-1-methyl-N-[(3R)-1,1,3-trimethyl-2,3-dihydroinden-4-yl]pyrazole-4-carboxamide mixtures (Treatments 6 and 8) increases yield more than the commercial standard (Treatment 3) in sorghum.

### Example 7

### Spring Wheat Stand and Vigor Study

A study was conducted to determine the effects of 3-(difluoromethyl)-1-methyl-N-[(3R)-1,1,3-trimethyl-2,3-dihydroinden-4-yl]pyrazole-4-carboxamide mixtures on spring wheat. The field was inoculated with common bunt. Treatments were applied to the seeds in a manner known by those of skill in the art. The results of this study can be seen below in Table 12.

TABLE 12
Spring Wheat Stand and Vigor

| | | Rate (g ai/100 | | |
|---|---|---|---|---|
| Treatment | Actives | kg seed) | Stand | Vigor |
| 1 | Untreated control | N/A | 334323 | 3.75 |
| 2 | Inoculant | N/A | 370260 | 4.25 |
| 3 | Clothianidin | 10 | 348480 | 4.25 |
| 4 | Commercial 3 way mix | 10 | 370260 | 4.5 |
| | (Clothianidin + | 3 | | |
| | Metalaxyl + | 1.5 | | |
| | Metconazole) + | 5 | | |
| | Ethaboxam | | | |
| 5 | Commercial 3 way mix | 10 | 411642 | 4.75 |
| | (Clothianidin + | 3 | | |
| | Metalaxyl + | 1.5 | | |
| | Metconazole) + | 1.0 | | |
| | 3-(Difluoromethyl)-1- | 5.0 | | |
| | methyl-N-[(3R)-1,1,3- | | | |
| | trimethyl-2,3-dihydroinden- | | | |
| | 4-yl]pyrazole-4- | | | |
| | carboxamide + Ethaboxam | | | |
| 6 | Clothianidin + | 10 | 310365 | 4.25 |
| | Tolclofos-methyl + | 10 | | |
| | Ethaboxam | 5.0 | | |
| 7 | Commercial 4 way | 2.6 | 386595 | 4.25 |
| | (Sedaxane + | 12 | | |
| | Difenoconazole + | 3 | | |
| | Mefenoxam + | 10 | | |
| | Thiamethoxam) | | | |
| 8 | 3-(Difluoromethyl)-1- | 1.0 | 348480 | 3.25 |
| | methyl-N-[(3R)-1,1,3- | 3.0 | | |
| | trimethyl-2,3-dihydroinden- | 5.0 | | |
| | 4-yl]pyrazole-4- | 10 | | |
| | carboxamide + | | | |
| | Metalaxyl + | | | |
| | Ethaboxam + | | | |
| | Clothianidin | | | |
| 9 | 3-(Difluoromethyl)-1- | 2.0 | 385506 | 4.5 |
| | methyl-N-[(3R)-1,1,3- | 3.0 | | |
| | trimethyl-2,3-dihydroinden- | 5.0 | | |
| | 4-yl]pyrazole-4- | 10 | | |
| | carboxamide + | | | |
| | Metalaxyl + | | | |
| | Ethaboxam + | | | |
| | Clothianidin | | | |

This study illustrates that a 3-(difluoromethyl)-1-methyl-N-[(3R)-1,1,3-trimethyl-2,3-dihydroinden-4-yl]pyrazole-4-carboxamide mixture with metconazole, metalaxyl, ethaboxam and clothianidin provides superior spring wheat plant stand (Treatment 5). This 3-(difluoromethyl)-1-methyl-N-[(3R)-1,1,3-trimethyl-2,3-dihydroinden-4-yl]pyrazole-4-carboxamide treatment also provided increased plant vigor/overall health (see Table 12 above).

### Example 8

### Sugar Beet Stand Study

A study was conducted to determine the effects of 3-(difluoromethyl)-1-methyl-N-[(3R)-1,1,3-trimethyl-2,3-dihydroinden-4-yl]pyrazole-4-carboxamide mixtures on sugar beet stand. Treatments were applied to the seeds in a manner known by those of skill in the art. The results of this study can be seen below in Table 13.

TABLE 13
Sugar Beet Stand-Plants Per Acre

| | | Rate (g ai/100 kg | |
|---|---|---|---|
| Treatment | Actives | seed) | Stand |
| 1 | Untreated Control | N/A | 203.5 |
| 2 | Inoculant Only | N/A | 178.0 |
| 3 | Tolclofos-methyl + | 0.42 | 189.0 |
| | Metconazole + | 0.21 | |
| | Metalaxyl | 0.14 | |
| 4 | Fungicide + | 0.14 | 202.5 |
| | Metalaxyl | | |
| 5 | 3-(Difluoromethyl)- | 0.04 | 197.5 |
| | 1-methyl-N-[(3R)- | 0.14 | |
| | 1,1,3-trimethyl-2,3- | | |
| | dihydroinden-4- | | |
| | yl]pyrazole-4- | | |
| | carboxamide + | | |
| | Metalaxyl | | |
| 6 | 3-(Difluoromethyl)- | 0.08 | 205.3 |
| | 1-methyl-N-[(3R)- | 0.14 | |
| | 1,1,3-trimethyl-2,3- | | |
| | dihydroinden-4- | | |
| | yl]pyrazole-4- | | |
| | carboxamide + | | |
| | Metalaxyl | | |
| 7 | 3-(Difluoromethyl)- | 0.04 | 195.5 |
| | 1-methyl-N-[(3R)- | 0.21 | |
| | 1,1,3-trimethyl-2,3- | 0.14 | |
| | dihydroinden-4- | | |
| | yl]pyrazole-4- | | |
| | carboxamide + | | |
| | Metconazole + | | |
| | Metalaxyl | | |
| 8 | 3-(Difluoromethyl)- | 0.04 | 195.0 |
| | 1-methyl-N-[(3R)- | 0.21 | |
| | 1,1,3-trimethyl-2,3- | 0.14 | |
| | dihydroinden-4- | | |
| | yl]pyrazole-4- | | |
| | carboxamide + | | |
| | Tolclofos-methyl + | | |
| | Metalaxyl | | |
| 9 | 3-(Difluoromethyl)- | 0.04 | 210.3 |
| | 1-methyl-N-[(3R)- | 0.21 | |
| | 1,1,3-trimethyl-2,3- | 0.42 | |
| | dihydroinden-4- | 0.14 | |
| | yl]pyrazole-4- | | |
| | carboxamide + | | |
| | Metconazole + | | |
| | Tolclofos-methyl + | | |
| | Metalaxyl | | |

As illustrated by Table 13, 3-(difluoromethyl)-1-methyl-N-[(3R)-1,1,3-trimethyl-2,3-dihydroinden-4-yl]pyrazole-4-carboxamide mixtures provided higher plant stand than the commercial standard treatment (Treatment 3) in sugar beet.

### Example 9

### Peas Yield Study

A study was conducted to determine the effects of 3-(difluoromethyl)-1-methyl-N-[(3R)-1,1,3-trimethyl-2,3-dihydroinden-4-yl]pyrazole-4-carboxamide mixtures on pole pea yield. Applicants expect to find the mixtures of the present application provide superior yield compared to commercially available SDHI formulations.

### Example 10

### Beans Yield Study

A study was conducted to determine the effects of 3-(difluoromethyl)-1-methyl-N-[(3R)-1,1,3-trimethyl-2,3-dihydroinden-4-yl]pyrazole-4-carboxamide mixtures on pole bean yield. Applicants expect to find the mixtures of the present application provide superior yield compared to commercially available SDHI formulations.

1. An agricultural mixture comprising 3-(difluoromethyl)-1-methyl-N-[(3R)-1,1,3-trimethyl-2,3-dihydroinden-4-yl]pyrazole-4-carboxamide, ethaboxam, and metalaxyl.

2. The mixture of claim 1 wherein the ratio of 3-(difluoromethyl)-1-methyl-N-[(3R)-1,1,3-trimethyl-2,3-dihydroinden-4-yl]pyrazole-4-carboxamide to ethaboxam is from about 1:0.125 to about 1:150 and the ratio of 3-(difluoromethyl)-1-methyl-N-[(3R)-1,1,3-trimethyl-2,3-dihydroinden-4-yl]pyrazole-4-carboxamide to metalaxyl is from about 1:0.025 to about 1:300.

3. The mixture of claim 1 wherein the ratio of 3-(difluoromethyl)-1-methyl-N-[(3R)-1,1,3-trimethyl-2,3-dihydroinden-4-yl]pyrazole-4-carboxamide to ethaboxam is from about 1:1 to about 1:18 and the ratio of 3-(difluoromethyl)-1-methyl-N-[(3R)-1,1,3-trimethyl-2,3-dihydroinden-4-yl]pyrazole-4-carboxamide to metalaxyl is from about 1:0.067 to about 1:20.

4. The mixture of claim 1 further comprising at least one compound selected from the group consisting of clothianidin, 2-[2-(2,5-dimethylphenoxymethyl)phenyl]-2-methoxy-N-methylacetamide, metconazole, and tolclofos-methyl.

5. The mixture of claim 4 wherein the compound is metconazole.

6. The mixture of claim 4 wherein the compound is clothianidin.

7. The mixture of claim 4 wherein the compound is 2-[2-(2,5-dimethylphenoxymethyl)phenyl]-2-methoxy-N-methylacetamide.

8. The mixture of claim 4 wherein the compound is tolclofos-methyl.

9. A method for increasing plant yield comprising applying the mixture of claim 1 onto a plant propagation material.

10. The method of claim 9 wherein the plant propagation material is a seed.

11. The method of claim 9 wherein the plant is a crop plant.

12. The method of claim 11 wherein the crop plant is selected from the group consisting of corn, soybeans, wheat, rice, canola, sorghum, and sugar beets.

13. The method of claim 10 wherein from about 0.1 to about 20 grams of 3-(difluoromethyl)-1-methyl-N-[(3R)-1,1,3-trimethyl-2,3-dihydroinden-4-yl]pyrazole-4-carboxamide, from about 2.5 to about 15 grams of ethaboxam, and from about 0.5 to about 30 grams of metalaxyl per 100 kg seed is applied to the seed.

14. The method of claim 13 wherein from about 0.5 to about 15 grams of 3-(difluoromethyl)-1-methyl-N-[(3R)-1,1,3-trimethyl-2,3-dihydroinden-4-yl]pyrazole-4-carboxamide, from about 3 to about 9 grams of ethaboxam, and from about 1 to about 10 grams of metalaxyl per 100 kg seed is applied to the seed.

15. The method of claim 10 wherein from about 0.5 to about 20 grams of metconazole per 100 kg seed is applied to the seed.

16. The method of claim 10 wherein from about 0.5 to about 20 grams of clothianidin per 100 kg seed is applied to the seed.

17. The method of claim 10 wherein from about 2 to about 15 grams of 2-[2-(2,5-dimethylphenoxymethyl)phenyl]-2-methoxy-N-methylacetamide per 100 kg seed is applied to the seed.

18. The method of claim 10 wherein from about 2 to about 15 grams of tolclofos-methyl per 100 kg seed is applied to the seed.

19. A method of controlling or preventing pest damage to a growing plant comprising applying the mixture of claim 1 onto a plant propagation material.

20. The method of claim 19 wherein the mixture further comprises at least one compound selected from the group consisting of neonicotinoid, 2-[2(2,5-dimethylphenoxymethyl)phenyl]-2-methoxy-N-methylacetamide, metconazole, and tolclofos-methyl.
